(19) United States
(12) Patent Application Publication
(10) Pub. No.: US 2022/0281473 A1
(43) Pub. Date: Sep. 8, 2022

(54) Driver Effort Augmentation to Indicate Trajectory Planner Feedback

(71) Applicants: Continental Automotive Systems, Inc., Auburn Hills, MI (US); Steering Solutions IP Holding Corporation, Auburn Hills, MI (US)

(72) Inventors: Joseph A. LaBarbera, Auburn Hills, MI (US); Scott A. Millsap, Grand Blanc, MI (US); Scott T. Sanford, Swartz Creek, MI (US); Michael S. Wyciechowski, Grand Blanc, MI (US)

(21) Appl. No.: 17/192,965

(22) Filed: Mar. 5, 2021

(51) Int. Cl. B60W 60/00; B60W 30/12; B62D 15/02; B60W 50/16; B60W 50/10

(52) U.S. Cl. CPC B60W 60/001; B60W 30/12; B62D 15/021; B60W 50/16; B60W 50/10; B60W 2552/53

(57) ABSTRACT

In a number of illustrative variations, a method may include providing an autonomous steering system that may include a steering interface. The method may include determining at least one trajectory; providing driving steering input on the steering interface; providing haptic feedback in the form of effort augmentation in the steering interface indicating the autonomous steering systems intent to remain on the at least one trajectory; and increasing or decreasing haptic feedback in intensity as a function of the magnitude of diversion from the at least one trajectory.

### TECHNICAL FIELD

The field to which the disclosure generally relates to includes steering systems.

### BACKGROUND

Vehicles may include steering systems. Autonomous driving and steering systems typically associated with “self-driving vehicles” may include lane-keeping assist systems, lane centering systems, or traffic assist systems that may plan the trajectory of a vehicle based on data gathered from internal or external sources. The data may include vehicle speed and acceleration, climate conditions, nearby vehicle data, or the like which may be collected from a variety of sensors and environment models. In the event that a user or driver wishes to change the trajectory of the vehicle, an autonomous driving system may exit an autonomous mode and allow the driver to control the trajectory of the vehicle.

### SUMMARY

A number of illustrative variations may include a method or product for handling driver intervention as it relates to trajectory planning in a steering system.

A product may include an autonomous steering system that may include a steering interface wherein the autonomous steering system may be constructed and arranged to concurrently receive and interpret driver steering input and steering commands and provide haptic feedback via the steering interface.

A method may include providing an autonomous steering system that may include a steering interface. The method may include determining at least one trajectory; providing driving steering input on the steering interface; providing haptic feedback in the form of effort augmentation in the steering interface indicating the autonomous steering system's intent to remain on the at least one trajectory; and increasing or decreasing haptic feedback in intensity as a function of the magnitude of diversion from the at least one trajectory.

A method may include providing an autonomous steering system that may include a steering interface. The steering interface may include a steering interface manipulation device constructed and arranged to provide haptic feedback. The method may include determining a first trajectory; providing driving steering input on the steering interface; providing haptic feedback in the form of effort augmentation in the steering interface via the steering interface manipulation device indicating the autonomous steering system's intent to remain on the first trajectory; increasing haptic feedback in intensity as a function of the magnitude of diversion from the at least one trajectory; determining a second trajectory correlating to the driving steering input on the steering interface; and decreasing haptic feedback in the form of effort augmentation in intensity as a function of the magnitude of diversion from the second trajectory.

Other illustrative variations within the scope of the invention will become apparent from the detailed description provided hereinafter. It should be understood that the detailed description, while disclosing variations of the invention, is intended for purposes of illustration only and are not intended to limit the scope of the invention.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

Select examples of variations within the scope of the invention will become more fully understood from the detailed description and the accompanying drawings, wherein:

FIG. 1 depicts an illustrative variation in which an autonomous steering system guides a car down a first trajectory and a driver intervenes in or cooperates with the autonomous steering system and in which the autonomous steering system provides haptic feedback and guides a car down a second trajectory parallel to the first trajectory.

FIG. 2 depicts an illustrative variation in which an autonomous steering system guides a car down a first trajectory and a driver intervenes in or cooperates with the autonomous steering system and in which the autonomous steering system provides haptic feedback and guides a car down a second trajectory in a different direction compared to the first trajectory, and in a completely different direction than the second trajectory shown in FIG. 1.

### DETAILED DESCRIPTION

The following description of the variations is merely illustrative in nature and is in no way intended to limit the scope of the invention, its application, or uses.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement such as but not limited to road wheels, treads, casters, rollers, propellers, gas thrusters, liquid thrusters, or ion driven thrusters, or any other known means of driven automotive vehicle movement.

As used herein, “wheels” or “wheel,” even when modified by a descriptive adjective such as but not limited to in the recitation of “steerable road wheels,” “steerable wheels,” “road wheels,” or “driven wheels,” may refer to a traditional wheel and tire arrangement, but may also refer to any modification to the traditional wheel and tire arrangement such as but not limited to rimless mag-lev tires, ball tires, or any other known means of automotive movement and/or steering such as but not limited to treads, casters, rollers, propellers, or gas thrusters, liquid thrusters, or ion driven thrusters, or rudders, wing flaps, or tail flaps and/or wings.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “haptic,” even when modified by a descriptive adjective may refer broadly to the use of technology to stimulate the sense of touch in persons, particularly where sense of touch relates to the perception and interpretation of information relating to a person's surrounding environment. Haptic feedback may include vibrations, forces, motions, or effort augmentation.

In a number of illustrative variations, a vehicle may have a steering system that allows a driver to change the vehicle's direction or divert it from a path that it may be traveling in. This steering system may operate in conjunction with a source of driven automotive vehicle movement such as a pair of driven road wheels. As a non-limiting example, a vehicle may be equipped with an internal combustion engine that mechanically drives a pair of rear road wheels to propel the vehicle forward along a road. In such an example, the vehicle may additionally equipped with a set of steerable front road wheels that may be manipulated by the steering system via a steering interface such as but not limited to a hand wheel to steer the vehicle to the left and to the right as the vehicle travels down the road. In such an example, the driven rear road wheels serve as the means of driven automotive vehicle movement, and the steerable pair of front road wheels as manipulated by the steering interface serves as the steering system. This is not the only means by which a vehicle is contemplated as being driven or steered in this disclosure. In a number illustrative variations the front road wheels may be the driven road wheels as well as the steerable road wheels. Similarly, the means of driven automotive vehicle movement does not need to be of the same kind as the steering means. That is, if the means of driven automotive vehicle movement comprises road wheels, the steering means does not need to also comprise road wheels. As a non-limiting example, it is contemplated that a snowmobile may be driven by a set of treads toward the rear of the vehicle and steered by a set of steerable skis toward the front of the vehicle. Additionally, it is contemplated that the means of driven automotive vehicle movement, such as but not limited to driven road wheels, and the steering means, such as but not limited to steerable road wheels, may change function or oscillate in function while in operation. As a non-limiting example, a vehicle comprising a pair of driven road wheels near the rear of the vehicle and further comprising a pair of steerable road wheels near the front of the vehicle may change driving modes and begin to utilize every road wheel available, including the front steerable road wheels, as driven road wheels while still maintaining the steerable property and steering function of the front steerable road wheels. It is similarly contemplated that driven road wheels may be intermittently or optionally used as steerable road wheels in some cases.

In a number of illustrative variations, a vehicle may comprise a steering system comprising a steering interface, and a set of steerable road wheels. The steering system may be of the electric power steering type wherein physical linkages mechanically communicate a manipulation of the steering interface to the steerable wheels. The steering system may be of the steer-by-wire type wherein physical mechanisms do not mechanically communicate a manipulation of the steering interface to the steerable road wheels and wherein a manipulation of the steering interface affects an associated manipulation of the steerable road wheels via the communication of electronic devices such as but not limited to sensors, transceivers and electronically excited actuators. In a number of illustrative variations the steering input may include any component that a user or drive my use to steer the vehicle with a portion of the user's or driver's body, which may include at least one hand and/or at least one foot. The steering interface may include, but is not limited to, at least one steering wheel or partial wheel, joy/control stick, one or more foot pedals, or one or more wheel toque or propulsion levers, arms or control devices. Such steering interfaces may be used to control other forms components having a similar functions as wheels to steer or propel the vehicle.

In a number of illustrative variations, a vehicle's steering system may also be autonomous in that the vehicle may steer itself toward a predetermined location that has been communicated to it without assistance or interference from a driver. The vehicle's steering system may have an obstacle avoidance system that allows the vehicle to sense objects in its path and avoid them. The vehicle's steering system may have a trajectory planning system that allows the vehicle to plan vehicle path. In some cases, the driver of the vehicle may wish to assist the vehicle in avoiding an object, or to change direction, such as changing driving lanes, of the vehicle without first communicating that wish to the vehicle in some other manner. In such a case, the driver may take control of the driver-side steering system controls and assist the autonomous steering system. In such a case, haptic feedback indicating the autonomous system's steering intent as well as any normal steering forces may be communicated to the driver via any interface through which the driver may use to communicate a driver steering intent to the steering system.

In a number of illustrative variations, an autonomous driving system may be programmed with any number of logic modules arranged to autonomously address a number of areas of control within the realm of vehicle steering and travel including but not limited to vehicle acceleration, vehicle braking, trajectory planning, and an autonomous steering system for control of the vehicle. The logic for the modules of the autonomous steering system may account for driver assistance or intervention. In a number of illustrative variations, while the vehicle is steering autonomously, the driver may attempt to cooperate or intervene in steering the vehicle. In some such cases, the autonomous steering system may allow the driver to intervene or cooperate in steering the vehicle while also determining the amount or level of deviation or variance to the autonomous steering that the driver is applying. In such cases, the autonomous steering system may calculate the variation to the vehicle travel direction or path as well and may continuously calculate new vehicle travel directions or trajectory paths as the driver intervenes such that if the driver stops intervening, the vehicle may begin autonomously steering according to one of the new travel directions or trajectory paths.

In a number of illustrative variations, in order to foster a cooperative steering system between a driver and an autonomous driving system, the sensors of an autonomous steering system may be configured to detect and identify steering input as driver input. The logic of the autonomous steering modules may also be configured to average, balance, or blend input identified as driver steering input with the autonomous system's steering input, thereby acting as a cooperative steering system.

In a number of illustrative variations, the logic of the autonomous steering modules may also be configured to provide haptic cues, such as but not limited to, vibration of a screen, steering wheel, or driver seat, or any other cue that may indicate to the driver how driver input, which may be concurrent with autonomous input, is being opposed, cooperated with, integrated or handled by the steering system. According to one illustrative variation, the logic of the autonomous steering modules may also be configured to provide haptic feedback in the form of effort augmentation in the steering wheel as a function of deviation from a trajectory path. The autonomous steering system may also provide for visual or audio cues correlating to the effort augmentation.

In a number of illustrative variations, a vehicle including an autonomous steering system may be traveling in a first trajectory path in a first lane of a road. The autonomous steering system may include lane-keeping assist functionality or similar systems to maintain vehicle position within the first lane of the road and which may be constructed and arranged to determine at least one trajectory. The at least one trajectory may include a first trajectory and a second trajectory. A driver may desire to change from the first lane to a second lane and may use a steering wheel of the vehicle to steer from the first lane to the second lane. The autonomous steering system may detect driver input in the form of use of the steering wheel and may also detect deviation from the first trajectory path and first lane. The autonomous steering system may provide haptic feedback to the driver to indicate deviation from the first trajectory path in the form of effort augmentation such as increased resistance in the rotation of the steering wheel or increasingly intense vibration of the steering wheel the greater that the vehicle deviates from the first trajectory. The autonomous steering system may perceive that the driver is in the process of changing lanes and may provide increasing effort augmentation as the vehicle deviates from the first trajectory and may provide decreasing effort augmentation as the vehicle enters a second trajectory path such as a second lane.

In a number of illustrative variations, while the vehicle is steering autonomously according to a predetermined vehicle path, if the driver attempts to divert the travel of the vehicle from the predetermined path by manipulating a steering interface of the vehicle in an attempt to steer the vehicle, the autonomous steering system may provide feedback to the steering interface with an intensity or frequency related to the manner or amount of attempted deviation from the predetermined vehicle path. As a non-limiting example, if the autonomous steering system is steering on a straight-forward bearing in a particular lane in accordance with a predetermined vehicle path, and the driver intervenes by attempting to steer the vehicle away from the straightforward bearing by applying force to a steering interface, the autonomous steering system may apply a counteractive force to the same steering interface in opposition to the driver's force input as a way of indicating to the driver that the driver is attempting to divert the vehicle from the predetermined path on which it is autonomously driving. The counteractive force applied against the driver's input force may be roughly proportional to the force applied to the steering interface by the driver or may increase or decrease in intensity as a function of the magnitude of diversion from the predetermined path that is being caused by the driver.

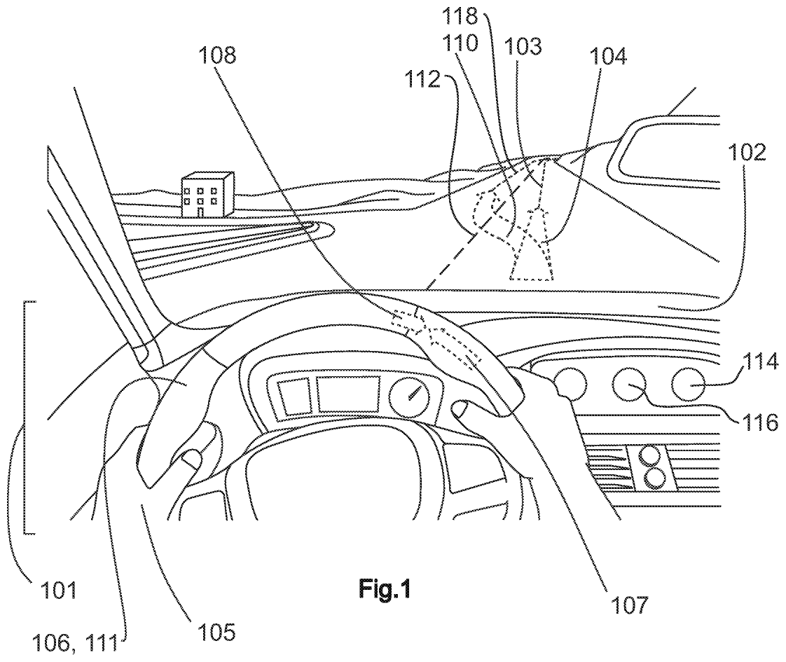

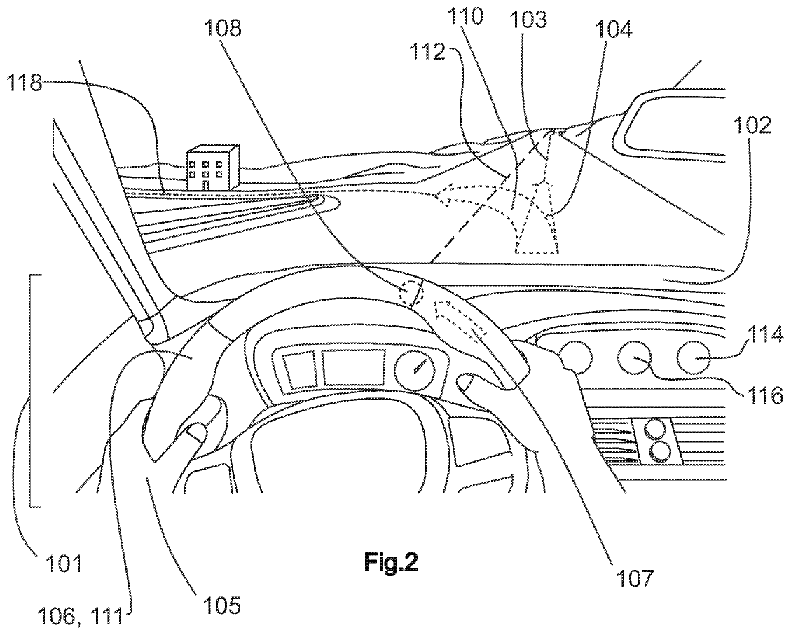

In a number of illustrative variations, a hand wheel serves as the steering interface for an autonomous steering system for a vehicle comprising steerable road wheels. In some such variations, if the driver intervenes or cooperates in steering, any mechanism used to automatically rotate the vehicle's hand wheel in conjunction with the autonomous steering system turning the vehicle's steerable road wheels may require the driver to apply steering effort with it or against it as the autonomous steering system simultaneously continues to steer the vehicle. In some cases, the autonomous steering system may blend the driver input with the autonomous steering input as a manner of determining a net steering input and utilize the net steering input as a control signal for any turning of the steerable road wheels and associated force feedback for the steering interface such as but not limited to an automatic turning of a hand wheel. As a non-limiting example, if a driver takes hold of a hand wheel of a vehicle while the vehicle is in autonomous steering mode, the autonomous steering system may continue to simultaneously steer the vehicle and may indicate its intent to steer to the right to the driver by rotating the hand wheel to the right in conjunction with turning the steerable road wheels of the vehicle to the right, however, while the driver still has hold of the hand wheel, the driver may sense this attempt to turn right by the autonomous system and may choose to intervene by augmenting or diminishing the amount of the turn. In some such cases, if the driver attempts to stop the hand wheel from turning right, the autonomous steering system will sense this and infer driver intent from this. The autonomous steering system may adjudge driver authority based at least upon the inferred driver intent, and either allow or disallow the driver to intervene in the steering. As a non-limiting example of when the autonomous system allows a driver to intervene, in some such cases the autonomous system may greatly reduce but not eliminate the amount of force it is applying to the hand wheel as a component of the autonomous steering system, thereby making it easy for the driver to commandeer the vehicle with natural road force feedback without giving the driver the impression that the autonomous steering system has completely relinquished control to the driver. In this way, the driver may be assured that the autonomous steering system is still attempting to control the vehicle and will return to controlling the vehicle after the driver releases the hand wheel. As another non-limiting example of when the autonomous system allows a driver to intervene, in some such cases the autonomous system may completely eliminate the amount of force it is applying to the hand wheel as a component of the autonomous steering system, thereby making easy for the driver to commandeer the vehicle and additionally indicating to the driver that the autonomous steering system has relinquished partial or full control to the driver. In some such cases, the driver may be thereby notified that the autonomous steering system is disabled and no longer attempting to control the vehicle. Additionally, in such cases, the driver may thereby be notified that the steering system will not return to controlling the vehicle after the driver releases the hand wheel unless the autonomous steering is re-enabled. In a number of variations, last handwheel movement indicating an evasive maneuver is the primary reason to scale down the effort augmentation, in order to increase the road feedback felt by the driver, for example, when the driver may want to go the other direction compared to the trajectory-planned turn (or decrease curvature magnitude). The cooperative steering (cooperative torque) feature will attenuate the trajectory-deviation effort buildup if it is deemed critical for the driver to feel natural road force feedback instead. Referring now to FIGS. 1 and 2, an illustrative variation in which an autonomous steering system 101 is steering a vehicle 102 on a first trajectory 103 in a first direction 104 when a driver 105 attempts to intervene by engaging the steering interface 106. The steering interface 106 may include a steering interface manipulation device 111 constructed and arranged to provide haptic feedback to the driver 105. The autonomous steering system 101 may determine that the driver's 105 intent to change or alter the first trajectory 103 in a first direction 104 to a second trajectory 118 in a second direction 110. The autonomous steering system 101 may permit the driver 105 to alter the first trajectory 103 by providing driving steering input 107 on the steering interface 106. The autonomous steering system 101 may provide haptic feedback 108 in the steering interface 106 indicating the autonomous system's steering intent to remain on the first trajectory 103 in a first direction 104 and avoid adverse road conditions or crossing lane indicators 112. The autonomous steering system 101 may increase haptic feedback 108 in intensity as a function of the magnitude of diversion from the first trajectory 104 and may decrease haptic feedback 108 in intensity as a function of the magnitude of diversion from the second trajectory 118. The high effort is intended as a deterrent from having the driver let go so the vehicle does not have to contain the energy of releasing control of the steering with a large trajectory deviation such as, but not limited to, lane or route change. The driver effort augmentation may be provided in a manner that is intuitive to the driver and conveys “state” information of whether or lot the driver has moved the vehicle into a safe location to resume hands-off autonomous driving. In a number of variations, an autonomous steering system may include a steering interface wherein the autonomous steering system is constructed and arranged to concurrently receive and interpret driver steering input and steering commands and provide haptic feedback via the steering interface, wherein the haptic feedback may include at least one of increased intensity with deviation from a projected path caused by a first speed of driver steering input and steering commands or decrease in intensity with a with deviation from a projected path caused by a second speed of driver steering input and steering commands. In a number of variations, the second speed of driver steering input and steering commands is faster or mor rapid than first speed of driver steering input and steering commands. For example, the second speed of driver steering input and steering commands may be as a result of an evasive maneuver by the driver. In a number of variations, the autonomous steering system may include handwheel velocity-based scaling of the driver effort augmentation. In a number of variations, the haptic feedback may increase in intensity within a first range of handwheel velocity, and the haptic feedback may decrease in intensity within second range of handwheel velocity or no haptic feedback may be provided within the second range of handwheel velocity.

As a non-limiting example, a driver 105 may wish to change lanes from the first trajectory 103 in a first direction 104 to a second trajectory 118 in a second direction 110 similar or different from the first direction 104. The driver may alter the first trajectory 103 by providing driving steering input 107 on the steering interface 106 and the vehicle 102 may move away from the first trajectory 104 towards the lane indicators 112 or an outer lateral boundary of the first trajectory 104 while the autonomous steering system 101 provides haptic feedback 108 in intensity as a function of the magnitude of diversion from the first trajectory 103. The autonomous steering system 101 may determine that the driver 105 intends to change or alter the first trajectory 103 in a first direction 104 and the autonomous steering system 101 may determine a second trajectory 118. The autonomous steering system 101 may determine that the driver 105 intends to change or alter the first trajectory 103 in a first direction 104 to a second trajectory 118 in a second direction 110 and permit the vehicle 102 to cross the lane indicators 112 or an outer lateral boundary of the first trajectory 104. When the autonomous steering system 101 has determined that the driver 105 intends to change or alter the first trajectory 103, or when the vehicle 102 crosses lane indicators 112 or an outer lateral boundary of the first trajectory 104, the autonomous steering system 101 may decrease haptic feedback 108 in intensity as a function of the magnitude of diversion from the second trajectory 118. The vehicle 102 may include an autonomous steering system 101 that may include audio cue indicators 114 or visual cue indicators 116 correlating to the effort augmentation or haptic feedback 108. In a number of variations, “discrete” aspects of the feature's feedback mechanism (e.g., visual auditory) may be used as confirmation that a new trajectory has been accepted as opposed to “continuous” aspects (i.e., a line on a UX light bar) that grows with added trajectory deviation, in conjunction with an effort increase.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention. Variation 1 may include a product that may include an autonomous steering system that may include a steering interface wherein the autonomous steering system may be constructed and arranged to concurrently receive and interpret driver steering input and steering commands and provide haptic feedback via the steering interface, wherein the haptic feedback comprises at least one of increased intensity with deviation from a projected path caused by a first speed of driver steering input and steering commands or decrease in intensity with a with deviation from a projected path caused by a second speed of driver steering input and steering commands.

Variation 2 may include the product of variation 1 wherein the autonomous steering system may be constructed and arranged to determine at least one trajectory.

Variation 3 may include the product in any of variations 1 through 2 wherein the steering interface may include a steering interface manipulation device constructed and arranged to provide haptic feedback.

Variation 4 may include the product in any of variations 1 through 3 wherein the steering interface may provide haptic feedback in the form of effort augmentation in the steering interface as a function of deviation from at least one trajectory.

Variation 5 may include the product in any of variations 1 through 4 wherein the steering interface may provide haptic feedback in the form of increasing effort augmentation in the steering interface as a function of increasing deviation from a first trajectory.

Variation 6 may include the product in any of variations 1 through 5 wherein the steering interface may provide haptic feedback in the form of decreasing effort augmentation in the steering interface as a function of decreasing deviation from a second trajectory.

Variation 7 may include the product in any of variations 1 through 6 and further may include a visual cue correlating to the effort augmentation.

Variation 8 may include the product in any of variations 1 through 7 and further may include an audio cue correlating to the effort augmentation.

Variation 9 may include a method that may include providing an autonomous steering system that may include a steering interface. The method may include determining at least one trajectory; providing driving steering input on the steering interface; providing haptic feedback in the form of effort augmentation in the steering interface indicating the autonomous steering systems intent to remain on the at least one trajectory; and increasing or decreasing haptic feedback in intensity as a function of the magnitude of diversion from the at least one trajectory.

Variation 10 may include the method in variation 8 wherein the at least one trajectory may include a first trajectory and further may include: determining a second trajectory; and decreasing haptic feedback in the form of effort augmentation in intensity as a function of the magnitude of diversion from the second trajectory.

Variation 11 may include the method in any of variations 9 through 10 and further may include providing a visual cue correlating to the effort augmentation.

Variation 12 may include the method in any of variations 9 through 11 and further may include providing an audio cue correlating to the effort augmentation.

Variation 13 may include a method that may include providing an autonomous steering system that may include a steering interface, the steering interface may include a steering interface manipulation device constructed and arranged to provide haptic feedback. The method may include determining a first trajectory; providing driving steering input on the steering interface; providing haptic feedback in the form of effort augmentation in the steering interface via the steering interface manipulation device indicating the autonomous steering systems intent to remain on the first trajectory; increasing haptic feedback in intensity as a function of the magnitude of diversion from the at least one trajectory; determining a second trajectory correlating to the driving steering input on the steering interface; and decreasing haptic feedback in the form of effort augmentation in intensity as a function of the magnitude of diversion from the second trajectory.

Variation 14 may include the method in variation 13 and further may include providing a visual cue correlating to the effort augmentation.

Variation 15 may include the method in any of variations 13 and 14 and further may include providing an audio cue correlating to the effort augmentation.

The above description of select variations within the scope of the invention is merely illustrative in nature and, thus, variations or variants thereof are not to be regarded as a departure from the spirit and scope of the invention.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A product comprising:
an autonomous steering system comprising a steering interface wherein the autonomous steering system is constructed and arranged to concurrently receive and interpret driver steering input and steering commands and provide haptic feedback via the steering interface, wherein the haptic feedback comprises at least one of increased intensity with deviation from a projected path caused by a first speed of driver steering input and steering commands or decrease in intensity with a with deviation from a projected path caused by a second speed of driver steering input and steering commands.

2. The product of claim 1 wherein the autonomous steering system is constructed and arranged to determine at least one trajectory.

3. The product of claim 1 wherein the steering interface comprises a steering interface manipulation device constructed and arranged to provide haptic feedback.

4. The product of claim 1 wherein the steering interface provides haptic feedback in the form of effort augmentation in the steering interface as a function of deviation from at least one trajectory.

5. The product of claim 1 wherein the steering interface provides haptic feedback in the form of increasing effort augmentation in the steering interface as a function of increasing deviation from a first trajectory.

6. The product of claim 1 wherein the steering interface provides haptic feedback in the form of decreasing effort augmentation in the steering interface as a function of decreasing deviation from a second trajectory.

7. The product of claim 1 further comprising a visual cue correlating to the effort augmentation.

8. The product of claim 1 further comprising an audio cue correlating to the effort augmentation.

9. A method comprising:
providing an autonomous steering system comprising a steering interface;
determining at least one trajectory;
providing driving steering input on the steering interface;
providing haptic feedback in the form of effort augmentation in the steering interface indicating the autonomous steering systems intent to remain on the at least one trajectory; and
increasing or decreasing haptic feedback in intensity as a function of the magnitude of diversion from the at least one trajectory.

10. The method of claim 8 wherein the at least one trajectory comprises a first trajectory and further comprising:
determining a second trajectory; and
decreasing haptic feedback in the form of effort augmentation in intensity as a function of the magnitude of diversion from the second trajectory.

11. The method of claim 8 further comprising providing a visual cue correlating to the effort augmentation.

12. The method of claim 8 further comprising providing an audio cue correlating to the effort augmentation.

13. A method comprising:
providing an autonomous steering system comprising a steering interface, the steering interface comprising a steering interface manipulation device constructed and arranged to provide haptic feedback;
determining a first trajectory;
providing driving steering input on the steering interface;
providing haptic feedback in the form of effort augmentation in the steering interface via the steering interface manipulation device indicating the autonomous steering systems intent to remain on the first trajectory;
increasing haptic feedback in intensity as a function of the magnitude of diversion from the at least one trajectory;
determining a second trajectory correlating to the driving steering input on the steering interface; and
decreasing haptic feedback in the form of effort augmentation in intensity as a function of the magnitude of diversion from the second trajectory.

14. The method of claim 8 further comprising providing a visual cue correlating to the effort augmentation.

15. The method of claim 8 further comprising providing an audio cue correlating to the effort augmentation.

16. A product comprising:
an autonomous steering system comprising a steering interface wherein the autonomous steering system is constructed and arranged to concurrently receive and interpret driver steering input and steering commands and provide haptic feedback via the steering interface, wherein the haptic feedback intensity is scaled based on handwheel velocity.

17. A product comprising:
an autonomous steering system comprising a steering interface wherein the autonomous steering system is constructed and arranged to concurrently receive and interpret driver steering input and steering commands and provide haptic feedback via the steering interface, wherein the haptic feedback increases in intensity within a first range of handwheel velocity, and the haptic feedback decreases in intensity within second range of handwheel velocity or no haptic feedback is provided within the second range of handwheel velocity.
